(19) United States
(12) Patent Application Publication
(10) Pub. No.: US 2015/0240112 A1
(43) Pub. Date: Aug. 27, 2015

(54) LIQUID EPOXY COATING COMPOSITIONS, METHODS, AND ARTICLES

(71) Applicant: 3M INNOVATIVE PROPERTIES COMPANY, Saint Paul, MN (US)

(72) Inventors: John C. Hulteen, Afton, MN (US); Aneece A. Yousif, Leander, TX (US)

(21) Appl. No.: 14/427,519

(22) PCT Filed: Sep. 10, 2013
(86) PCT No.: PCT/US2013/058845

§ 371 Date: Mar. 11, 2015

Related U.S. Application Data
(60) Provisional application No. 61/701,993, filed on Sep. 17, 2012.

(51) Int. Cl. C09D 163/00; C09D 151/04

(52) U.S. Cl. CPC C09D 163/00; C09D 151/04

(57) ABSTRACT

Liquid coating compositions provide protective epoxy coatings, particularly flexible and damage-resistant epoxy coatings. Such coating compositions include a liquid epoxy resin, a reactive flexibilizing agent, and core-shell rubber particles.

### BACKGROUND

Liquid resins are commonly used for corrosion protection of steel pipelines and metals used in the oil, gas, and construction industries. These coatings can be applied to a variety of parts for corrosion protection. Exemplary applications include valves, pumps, tapping saddles, manifolds, pipe hangers, ladders, mesh, cable and wire rope, I-beams, rebar, column coils, anchor plates, chairs, and the like.

A desirable coating has excellent physical properties to limit damage during transit, installation, and operation. Damage to the coating can lead to higher potential corrosion of the metallic surface that the coating is protecting and can ultimately lead to a decrease in service life. Also, a coated substrate is often bent during installation, for example, to fit into the contour of the land, and should be flexible enough to prevent damage to the coating. Thus, a balance of properties, particularly between set-to-touch time, adhesion to steel, and flexibility, is difficult but important to achieve for a liquid epoxy coating composition.

### SUMMARY

The present disclosure provides liquid coating compositions that provide protective epoxy coatings, particularly flexible and damage-resistant epoxy coatings. Such coating compositions include a liquid epoxy resin, a reactive flexibilizing agent, and core-shell rubber particles. Significantly, the combination of the reactive flexibilizing agent and the core-shell rubber particles provide improved flexibility of a resultant coating, at both room temperature and low temperature.

In one embodiment, there is provided a curable coating composition having a first part and a second part, the curable coating composition including: a liquid epoxy resin in the first part of the curable coating composition; core-shell rubber particles in the first part or the second part or both; a reactive flexibilizing agent in the first part or the second part or both; and a curing agent in the second part of the curable coating composition, the curing agent having at least two amino groups of formula —NR¹H where R¹ is selected from hydrogen, alkyl, aryl, or alkylaryl.

In one embodiment, there is provided a curable coating composition having a first part and a second part, the curable coating composition including: a liquid epoxy resin in the first part of the curable coating composition; core-shell rubber particles in the first part or the second part or both; wherein the core-shell rubber particles are present in an amount of 0.1 wt-% to 50 wt-%, based on the total weight of the liquid epoxy resin; a reactive flexibilizing agent in the first part of the curable coating composition; wherein the reactive flexibilizing agent is present in an amount of 0.1 wt-% to 50 wt-%, based on the total weight of the liquid epoxy resin; and a curing agent in the second part of the curable coating composition, the curing agent having at least two amino groups of formula —NR¹H where R¹ is selected from hydrogen, alkyl, aryl, or alkylaryl.

In one embodiment, there is provided a method of protecting an article, the method including: coating at least a portion of the article with a curable coating composition including components that include: a liquid epoxy resin; core-shell rubber particles; a reactive flexibilizing agent; and a curing agent having at least two amino groups of formula —NR¹H where R¹ is selected from hydrogen, alkyl, aryl, or alkylaryl; and curing (i.e., polymerizing and/or crosslinking) the composition while disposed on the article.

The present disclosure also provides cured coatings and articles having a cured coating thereon.

In one embodiment, there is provided a cured coating including a reaction product of a curable coating composition that includes: a liquid epoxy resin; core-shell rubber particles; a reactive flexibilizing agent; and a curing agent having at least two amino groups of formula —NR¹H where R¹ is selected from hydrogen, alkyl, aryl, or alkylaryl.

In one embodiment, there is provided an article that includes: a substrate having an outer surface; and a cured coating disposed on at least a portion of the outer surface; wherein the cured coating is prepared by curing a curable coating composition of the present disclosure.

In one embodiment, an article is provided that is prepared by a method of the present disclosure.

In one embodiment, there is provided an article including: a substrate having an outer surface; and a cured coating disposed on at least a portion of the outer surface; wherein the cured coating includes a reaction product of a curable coating composition including: a liquid epoxy resin; core-shell rubber particles; a reactive flexibilizing agent; and a curing agent having at least two amino groups of formula —NR¹H where R¹ is selected from hydrogen, alkyl, aryl, or alkylaryl.

Herein, “room temperature” or “RT” refers to a temperature of 20° C. to 30° C. or preferably 20° C. to 25° C.

The terms “comprises” and variations thereof do not have a limiting meaning where these terms appear in the description and claims.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

In this application, terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise. The term “and/or” means one or all of the listed elements or a combination of any two or more of the listed elements.

Also herein, all numbers are assumed to be modified by the term “about” and preferably by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used.

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

FIG. 1 is a perspective view of a coating disposed on a pipe substrate, in accordance with an exemplary embodiment of the present disclosure.

### DETAILED DESCRIPTION OF ILLUSTRATIVE EMBODIMENTS

The present disclosure is generally related to the field of corrosion protective epoxy coatings. In particular, the present disclosure relates to more flexible and damage-resistant liquid epoxy coatings with strong adhesion and reduced set-to-touch time.

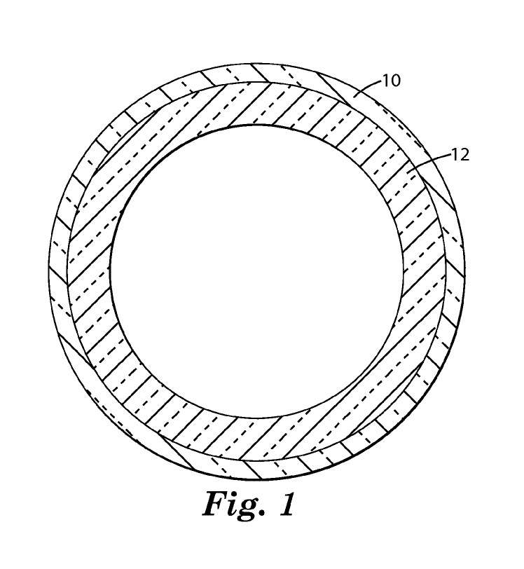

FIG. 1 is a perspective view of a coating 10 of the present disclosure in use with a substrate, for example a pipe 12. Coating 10 is derived from a composition of the present disclosure that increases the elongation ability of coating 10 without negatively affecting other coating properties. The elongation ability of coating 10 results in a flexible coating that is damage resistant. Coating 10 can be a single layer or the outermost layer of a multi-layer thermoset epoxy coating and capable of withstanding the normal wear and tear involved in transportation and use of a pipe 12 or other substrate. Thus, exemplary embodiments of the present disclosure provide a coating 10 that is a more flexible while maintaining adhesion with reduced set-to-touch time characteristics.

These characteristics make coating 10 particularly desirable for protecting pipes, rebar, and other metal substrates, particularly steel substrates, during transportation and use at construction sites even in extreme environmental conditions. While FIG. 1 is described in reference to a pipe as the substrate, coating 10 can be applied to any substrate, preferably a metal-containing substrate in which corrosion resistance is a desired characteristic. Such substrates include, but are not limited to, pipes, valves, pumps, tapping saddles, manifolds, pipe hangers, ladders, mesh, cable and wire rope, I-beams, rebar, column coils, anchor plates, and chairs.

A coating composition of the present disclosure can be applied to a variety of substrate surfaces. Suitable substrates include polymeric materials, glasses, ceramic materials, composite materials, and metal-containing surfaces. The coatings are particularly useful on metal-containing substrates such as metals, metal oxides, and various alloys. Steel substrates are of particular interest. The coatings can provide chemical resistance, corrosion resistance, water resistance, or a combination thereof.

A coating composition of the present disclosure could be applied directly to a substrate, e.g., a steel pipe, but could also be applied on top of one or more coatings directly adhered to the substrate, particularly steel. For example, the coating composition of the present invention can be applied directly on a steel pipe. It can be applied directly on a weld in a steel pipe and the area surrounding the weld such that it may also overcoat a portion of, for example, a fusion bonded epoxy coating thereon. Alternatively, it can be used in a two-layer (dual-coat or dual-layer) system and can provide unique characteristics, as each layer can be designed to produce performance results that exceed those of a single-layer coating. Thus, the composition of the present disclosure can function as a top layer or top coat of a dual-layer coating system. The use of two layers, particularly when the underlayer is a fusion bonded epoxy, can significantly improve damage resistance in comparison with a single layer (i.e., single coating). The primary coating layer (i.e., layer directly coated on the substrate) is typically a coating material designed as part of a corrosion protection system. This means the primary layer has good initial adhesion and maintains adhesion after exposure to hot water or other environmental factors. Exemplary multi-layered systems are described in the book entitled Fusion-Bonded Epoxy: A Foundation for Pipeline Corrosion Protection, by J. Allen Kehr, 2003, Nace Press, Chapter 3. An example of a primary layer can be prepared from 3M SCOTCHKOTE SK6233 8G a one-part, heat curable, thermosetting epoxy coating powder from 3M, St. Paul, Minn.

A curable coating composition for forming a coating 10 of the present disclosure includes components such as a liquid epoxy resin, a reactive flexibilizing agent, core-shell rubber particles, and a curing agent (i.e., curative). Cured coating 10 formed of the composition has desirable flexibility, strong adhesion, and reduced set-to-touch time. Where set-to-touch time is defined as the amount of time for the composition to cure and be dry to the touch. Proper selection of the component materials and the amounts of such components is important for achieving a balance of properties for the cured coating (e.g., flexibility, set-to-touch time, adhesion, and appearance).

A curable coating composition of the present disclosure is typically a two-part epoxy-based formulation. In one embodiment, a curable coating composition is provided that has a first part and a second part. An exemplary curable coating composition contains a) a liquid crosslinkable epoxy resin, a reactive flexibilizing agent, and core-shell rubber particles in the first part of the curable coating composition, b) a curing agent in the second part of the curable coating composition. The curable coating compositions (upon mixing the parts) are typically applied to at least one surface of a substrate and then cured.

Preferred combinations of components (in terms of selection of components and amounts of components) produce a nonporous coating once applied to a substrate and cured. In this context, “nonporous” means that the density (i.e., specific gravity) of a cured coating is reduced by no more than 15% (i.e., 0-15%), more preferably, by no more than 10% (i.e., 0-10%), and even more preferably, by no more than 5% (i.e., 0-5%), relative to the theoretical density of the coating composition. Thus, particularly preferred embodiments of the cured coating exhibit little or no reduction in density upon curing and little or no porosity. Typically, any residual porosity present in a cured coating may be caused by moisture in the composition. Porous coatings typically have poor gouge resistance. Compositions for forming nonporous coatings typically do not include components that have extensive pore-forming capabilities, such as heat expandable functional groups or fillers, blowing agents, etc.

Curable coating compositions of the present disclosure are often in the form of a two-part composition (although more parts can be used if desired). The epoxy resin is typically separated from the curing agent prior to use of the curable coating composition. That is, the epoxy resin is typically in a first part and the curing agent is typically in a second part of the curable coating composition. The first part can include other components that do not react with the epoxy resin or that react with only a portion of the epoxy resin. Likewise, the second part can include other components that do not react with the curing agent or that react with only a portion of the curing agent. When the various parts are mixed together, the components react to form the cured coating composition.

The epoxy resin that is included in the first part of the curable coating composition contains at least one epoxy functional group (i.e., oxirane group) per molecule. As used herein, the term oxirane group refers to the following divalent group.

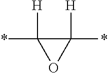 [SMILES: *C1OC1*]

The asterisks denote a site of attachment of the oxirane group to another group. If the oxirane group is at the terminal position of the epoxy resin, the oxirane group is typically bonded to a hydrogen atom.

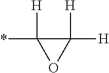 [SMILES: *C1CO1]

This terminal oxirane group is often part of a glycidyl group.

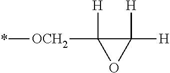

The epoxy resin has at least one oxirane group per molecule and often has at least two oxirane groups per molecule. For example, the epoxy resin can have 1 to 10, 2 to 10, 1 to 6, 2 to 6, 1 to 4, or 2 to 4 oxirane groups per molecule. The oxirane groups are usually part of a glycidyl group.

Epoxy resins can be a single material or a mixture of materials selected to provide the desired viscosity characteristics before curing and to provide the desired mechanical properties after curing. If the epoxy resin is a mixture of materials, at least one of the epoxy resins in the mixture is usually selected to have at least two oxirane groups per molecule. For example, a first epoxy resin in the mixture can have two to four or more oxirane groups and a second epoxy resin in the mixture can have one to four oxirane groups. In some of these examples, the first epoxy resin is a first glycidyl ether with two to four glycidyl groups and the second epoxy resin is a second glycidyl ether with one to four glycidyl groups.

The portion of the epoxy resin molecule that is not an oxirane group (i.e., the epoxy resin molecule minus the oxirane groups) can be aromatic, aliphatic or a combination thereof and can be linear, branched, cyclic, or a combination thereof. The aromatic and aliphatic portions of the epoxy resin can include heteroatoms or other groups that are not reactive with the oxirane groups. That is, the epoxy resin can include halo groups, oxy groups such as in an ether linkage group, thio groups such as in a thio ether linkage group, carbonyl groups, carbonyloxy groups, carbonylimino groups, phosphono groups, sulfono groups, nitro groups, nitrile groups, and the like. The epoxy resin can also be a silicone-based material such as a polydiorganosiloxane-based material.

Although the epoxy resin can have any suitable molecular weight, the weight average molecular weight is usually at least 100 grams/mole, at least 150 grams/mole, at least 175 grams/mole, at least 200 grams/mole, at least 250 grams/mole, or at least 300 grams/mole. The weight average molecular weight can be up to 50,000 grams/mole or even higher for polymeric epoxy resins. The weight average molecular weight is often up to 40,000 grams/mole, up to 20,000 grams/mole, up to 10,000 grams/mole, up to 5,000 grams/mole, up to 3,000 grams/mole, or up to 1,000 grams/mole. For example, the weight average molecular weight can be in the range of 100 to 50,000 grams/mole, in the range of 100 to 20,000 grams/mole, in the range of 10 to 10,000 grams/mole, in the range of 100 to 5,000 grams/mole, in the range of 200 to 5,000 grams/mole, in the range of 100 to 2,000 grams/mole, in the range of 200 to 2,000 gram/mole, in the range of 100 to 1,000 grams/mole, or in the range of 200 to 1,000 grams/mole.

Suitable epoxy resins are liquid at room temperature (“RT”, as used herein, this refers to a temperature of 20° C. to 30° C. or preferably 20° C. to 25° C.).

In most embodiments, the epoxy resin is a glycidyl ether. Exemplary glycidyl ethers can be of Formula (I).

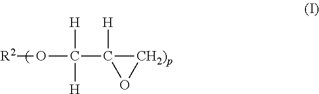

In Formula (I), group R² is a p-valent group that is aromatic, aliphatic, or a combination thereof. Group R² can be linear, branched, cyclic, or a combination thereof. Group R² can optionally include halo groups, oxy groups, thio groups, carbonyl groups, carbonyloxy groups, carbonylimino groups, phosphono groups, sulfono groups, nitro groups, nitrile groups, and the like. Although the variable p can be any suitable integer greater than or equal to 1, p is often an integer in the range of 2 to 10, in the range of 2 to 6, or in the range of 2 to 4.

In some exemplary epoxy resins of Formula (I), the variable p is equal to 2 (i.e., the epoxy resin is a diglycidyl ether) and R² includes an alkylene (i.e., an alkylene is a divalent radical of an alkane and can be referred to as an alkane-diyl), heteroalkylene (i.e., a heteroalkylene is a divalent radical of a heteroalkane and can be referred to as a heteroalkane-diyl), arylene (i.e., a divalent radical of a arene compound), or combination thereof. Suitable alkylene groups often have 1 to 20 carbon atoms, 1 to 12 carbon atoms, 1 to 8 carbon atoms, or 1 to 4 carbon atoms. Suitable heteroalkylene groups often have 2 to 50 carbon atoms, 2 to 40 carbon atoms, 2 to 30 carbon atoms, 2 to 20 carbon atoms, 2 to 10 carbon atoms, or 2 to 6 carbon atoms with 1 to 10 heteroatoms, 1 to 6 heteroatoms, or 1 to 4 heteroatoms. The heteroatoms in the heteroalkylene can be selected from oxy, thio, or —NH— groups but are often oxy groups. Suitable arylene groups often have 6 to 18 carbon atoms or 6 to 12 carbon atoms. For example, the arylene can be phenylene or biphenylene. Group R² can further optionally include halo groups, oxy groups, thio groups, carbonyl groups, carbonyloxy groups, carbonylimino groups, phosphono groups, sulfono groups, nitro groups, nitrile groups, and the like. The variable p is usually an integer in the range of 2 to 4.

Some epoxy resins of Formula (I) are diglycidyl ethers where R² includes (a) an arylene group or (b) an arylene group in combination with an alkylene, heteroalkylene, or both. Group R² can further include optional groups such as halo groups, oxy groups, thio groups, carbonyl groups, carbonyloxy groups, carbonylimino groups, phosphono groups, sulfono groups, nitro groups, nitrile groups, and the like. These epoxy resins can be prepared, for example, by reacting an aromatic compound having at least two hydroxyl groups with an excess of epichlorohydrin. Examples of useful aromatic compounds having at least two hydroxyl groups include, but are not limited to, resorcinol, catechol, hydroquinone, p,p′-dihydroxydibenzyl, p,p′-dihydroxyphenylsulfone, p,p′-dihydroxybenzophenone, 2,2′-dihydroxyphenyl sulfone, and p,p′-dihydroxybenzophenone. Still other examples include the 2,2′, 2,3′, 2,4′, 3,3′, 3,4′, and 4,4′ isomers of dihydroxydiphenylmethane, dihydroxydiphenyldimethylmethane, dihydroxydiphenylethylmethylmethane, dihydroxydiphenylmethylpropylmethane, dihydroxydiphenylethylphenylmethane, dihydroxydiphenylpropylenphenylmethane, dihydroxydiphenylbutylphenylmethane, dihydroxydiphenyltolylethane, dihydroxydiphenyltolylmethylmethane, dihydroxydiphenyldicyclohexylmethane, and dihydroxydiphenylcyclohexane.

Some commercially available diglycidyl ether epoxy resins of Formula (I) are derived from bisphenol A (i.e., bisphenol A is 4,4′-dihydroxydiphenylmethane). Examples include, but are not limited to, those available under the trade designations EPON (e.g., EPON 828, EPON 872, and EPON 1001) from Momentive Specialty Chemicals, Inc., Columbus, Ohio, DER (e.g., DER 331, DER 332, and DER 336) from Dow Chemical Co., Midland, Mich., and EPICLON (e.g., EPICLON 850) from Dainippon Ink and Chemicals, Inc., Chiba, Japan. Other commercially available diglycidyl ether epoxy resins are derived from bisphenol F (i.e., bisphenol F is 2,2′-dihydroxydiphenylmethane). Examples include, but are not limited to, those available under the trade designations DER (e.g., DER 334) from Dow Chemical Co., and EPICLON (e.g., EPICLON 830) from Dainippon Ink and Chemicals, Inc.

Other epoxy resins of Formula (I) are diglycidyl ethers of a poly(alkylene oxide) diol. These epoxy resins also can be referred to as diglycidyl ethers of a poly(alkylene glycol) diol. The variable p is equal to 2 and R² is a heteroalkylene having oxygen heteroatoms. The poly(alkylene glycol) portion can be a copolymer or homopolymer and often includes alkylene units having 1 to 4 carbon atoms. Examples include, but are not limited to, diglycidyl ethers of poly(ethylene oxide) diol, diglycidyl ethers of poly(propylene oxide) diol, and diglycidyl ethers of poly(tetramethylene oxide) diol. Epoxy resins of this type are commercially available from Polysciences, Inc., Warrington, Pa., such as those derived from a poly(ethylene oxide) diol or from a poly(propylene oxide) diol having a weight average molecular weight of about 400 grams/mole, about 600 grams/mole, or about 1000 gram/mole.

Still other epoxy resins of Formula (I) are diglycidyl ethers of an alkane diol (R² is an alkylene and the variable p is equal to 2). Examples include a diglycidyl ether of 1,4-dimethanol cylcohexyl, diglycidyl ether of 1,4-butanediol, and a diglycidyl ether of the cycloaliphatic diol formed from a hydrogenated bisphenol A such as those commercially available under the trade designations EPONEX (e.g., EPONEX 1510) from Momentive Specialty Chemicals, Inc., Columbus, Ohio, and EPALLOY (e.g., EPALLLOY 5001) from CVC Thermoset Specialties, Moorestown, N.J.

For some applications, the epoxy resins chosen for use in the curable coating compositions are novolac epoxy resins, which are glycidyl ethers of phenolic novolac resins. These resins can be prepared, for example, by reaction of phenols with an excess of formaldehyde in the presence of an acidic catalyst to produce the phenolic novolac resin. Novolac epoxy resins are then prepared by reacting the phenolic novolac resin with epichlorihydrin in the presence of sodium hydroxide. The resulting novolac epoxy resins typically have more than two oxirane groups and can be used to produce cured coating compositions with a high crosslinking density. The use of novolac epoxy resins can be particularly desirable in applications where corrosion resistance, water resistance, chemical resistance, or a combination thereof is desired. One such novolac epoxy resin is poly[(phenyl glycidyl ether)-co-formaldehyde]. Other suitable novolac resins are commercially available under the trade designations ARALDITE (e.g., ARALDITE GY289, ARALDITE EPN 1183, ARALDITE EP 1179, ARALDITE EPN 1139, and ARALDITE EPN 1138) from Huntsman Corp., Salt Lake City, Utah, EPALLOY (e.g., EPALLOY 8230) from CVC Thermoset Specialties, Moorestown, N.J., and DEN (e.g., DEN 424 and DEN 431) from Dow Chemical, Midland, Mich.

Yet other epoxy resins include silicone resins with at least two glycidyl groups and flame retardant epoxy resins with at least two glycidyl groups (e.g., a brominated bisphenol-type epoxy resin having with at least two glycidyl groups such as that commercially available from Dow Chemical Co., Midland, Mich., under the trade designation DER 580).

The epoxy resin is often a mixture of materials. For example, the epoxy resins can be selected to be a mixture that provides the desired viscosity or flow characteristics prior to curing. The mixture can include at least one first epoxy resin that is referred to as a reactive diluent that has a lower viscosity and at least one second epoxy resin that has a higher viscosity. The reactive diluent tends to lower the viscosity of the epoxy resin composition and often has either a branched backbone that is saturated or a cyclic backbone that is saturated or unsaturated. Examples include, but are not limited to, the diglycidyl ether of resorcinol, the diglycidyl ether of cyclohexane dimethanol, the diglycidyl ether of neopentyl glycol, and the triglycidyl ether of trimethylolpropane. Diglycidyl ethers of cyclohexane dimethanol are commercially available under the trade designations HELOXY MODIFIER (e.g., HELOXY MODIFIER 107) from Momentive Specialty Chemicals, Columbus, Ohio, and EPODIL (e.g., EPODIL 757) from Air Products and Chemical Inc., Allentown, Pa. Other reactive diluents have only one functional group (i.e., oxirane group) such as various monoglycidyl ethers. Some example monoglycidyl ethers include, but are not limited to, alkyl glycidyl ethers with an alkyl group having 1 to 20 carbon atoms, 1 to 12 carbon atoms, 1 to 8 carbon atoms, or 1 to 4 carbon atoms. Some monoglycidyl ethers that are commercially available include those under the trade designation EPODIL from Air Products and Chemical, Inc., Allentown, Pa., such as EPODIL 746 (2-ethylhexyl glycidyl ether), EPODIL 747 (aliphatic glycidyl ether), and EPODIL 748 (aliphatic glycidyl ether).

The epoxy resin is cured by reacting with a curing agent that is typically in a second part of the curable coating composition. Stated differently, the epoxy resin is typically separated from the curing agent during storage or prior to using the curable coating composition. The curing agent has at least two primary amino groups, at least two secondary amino groups, or combinations thereof. That is, the curing agent has at least two groups of formula —NR¹H where R¹ is selected from hydrogen, alkyl, aryl, or alkylaryl. Suitable alkyl groups often have 1 to 12 carbon atoms, 1 to 8 carbon atoms, 1 to 6 carbon atoms, or 1 to 4 carbon atoms. The alkyl group can be cyclic, branched, linear, or a combination thereof. Suitable aryl groups usually have 6 to 12 carbon atom such as a phenyl or biphenyl group. Suitable alkylaryl groups can be either an alkyl substituted with an aryl or an aryl substituted with an alkyl. The same aryl and alkyl groups discussed above can be used in the alkylaryl groups.

When the first part and the second part of the curable coating composition are mixed together, the primary and/or secondary amino groups of the curing agent react with the oxirane groups of the epoxy resin. This reaction opens the oxirane groups and covalently bonds the curing agent to the epoxy resin. The reaction results in the formation of divalent groups of formula —OCH₂—CH₂—NR¹— where R¹ is equal to hydrogen, alkyl, aryl, or alkylaryl.

The curing agent minus the at least two amino groups (i.e., the portion of the curing agent that is not an amino group) can be any suitable aromatic group, aliphatic group, or combination thereof. Some amine curing agents are of Formula (II) with the additional limitation that there are at least two primary amino groups, at least two secondary amino groups, or at least one primary amino group and at least one secondary amino group.

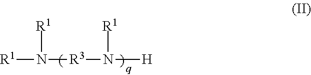

Each R¹ group is independently hydrogen, alkyl, aryl, or alkylaryl. Suitable alkyl groups for R¹ often have 1 to 12 carbon atoms, 1 to 8 carbon atoms, 1 to 6 carbon atoms, or 1 to 4 carbon atoms. The alkyl group can be cyclic, branched, linear, or a combination thereof. Suitable aryl groups for R¹ often have 6 to 12 carbon atoms such as a phenyl or biphenyl group. Suitable alkylaryl groups for R¹ can be either an alkyl substituted with an aryl or an aryl substituted with an alkyl. The same aryl and alkyl groups discussed above can be used in the alkylaryl groups. Each R³ is independently an alkylene, heteroalkylene, or combination thereof. Suitable alkylene groups often have 1 to 18 carbon atoms, 1 to 12 carbon atoms, 1 to 8 carbon atoms, 1 to 6 carbon atoms, or 1 to 4 carbon atoms. Suitable heteroalkylene groups have at least one oxy, thio, or —NH— group positioned between two alkylene groups. Suitable heteroalkylene groups often have 2 to 50 carbon atoms, 2 to 40 carbon atoms, 2 to 30 carbon atoms, 2 to 20 carbon atoms, or 2 to 10 carbon atoms and up to 20 heteroatoms, up to 16 heteroatoms, up to 12 heteroatoms, or up to 10 heteroatoms. The heteroatoms are often oxy groups. The variable q is an integer equal to at least one and can be up to 10 or higher, up to 5, up to 4, or up to 3.

Some amine curing agents can have an R³ group selected from an alkylene group. Examples include, but are not limited to, ethylene diamine, diethylene diamine, diethylene triamine, triethylene tetramine, propylene diamine, tetraethylene pentamine, hexaethylene heptamine, hexamethylene diamine, 2-methyl-1,5-pentamethylene diamine, 1-amino-3-aminomethyl-3,3,5-trimethylcyclohexane (also called isophorene diamine), 1,3 bis-aminomethyl cyclohexane, and the like. Other amine curing agents can have an R³ group selected from a heteroalkylene group such as a heteroalkylene having oxygen heteroatoms. For example, the curing agent can be a compound such as aminoethylpiperazine, 4,7,10-trioxatridecane-1,13-diamine (TTD) (available from TCI America, Portland, Oreg.), or a poly(alkylene oxide) diamine (also called polyether diamines) such as a poly(ethylene oxide) diamine, poly(propylene oxide) diamine, or a copolymer thereof. Commercially available polyether diamines are available under the trade designation JEFFAMINE from Huntsman Corp., Salt Lake City, Utah.

Still other amine curing agents can be formed by reacting a polyamine (i.e., a polyamine refers to an amine with at least two amino groups selected from primary amino groups and secondary amino groups) with another reactant to form an amine-containing adduct having at least two amino groups. For example, a polyamine can be reacted with an epoxy resin to form an adduct having at least two amino groups. If a polymeric diamine is reacted with a dicarboxylic acid in a molar ratio of diamine to dicarboxylic acid that is greater than or equal to 2:1, a polyamidoamine having two amino groups can be formed. In another example, if a polymeric diamine is reacted with an epoxy resin having two glycidyl groups in a molar ratio of diamine to epoxy resin greater than or equal to 2:1, an amine-containing adduct having two amino groups can be formed. Such a polyamidoamine can be prepared as described, for example, in U.S. Pat. No. 5,629,380 (Baldwin et al.). A molar excess of the polymeric diamine is often used so that the curing agent includes both the amine-containing adduct plus free (non-reacted) polymeric diamine. For example, the molar ratio of diamine to epoxy resin with two glycidyl groups can be greater than 2.5:1, greater than 3:1, greater than 3.5:1, or greater than 4:1. Even when epoxy resin is used to form the amine-containing adduct in the second part of the curable coating composition, additional epoxy resin is present in the first part of the curable coating composition.

The curing agent can also be an aromatic ring substituted with multiple amino groups or with amino-containing groups. Such curing agents include, but are not limited to, xylene diamines (e.g., meta-xylene diamine) or similar compounds. For example, such curing agents are commercially available under the trade designations ANCAMINE (e.g., ANCAMINE 2609) from Air Products, Allentown, Pa., and ARADUR (e.g., ARADUR 2965 or ARADUR 3246) from Huntsman Corp., Salt Lake City, Utah.

Various combinations of epoxy resins can be used if desired. Analogously, various combinations of curing agents can be used if desired.

The curing reaction can occur at room temperature or higher. In some applications, the curing occurs at an elevated temperature (e.g., temperatures above 100° C. or above 120° C. or above 150° C.). The ratio of amine hydrogen equivalent weight to epoxy equivalent weight is often selected to be close to 1:1 (e.g., 1.2:1 to 1:1.2, 1.1:1 to 1:1.1, or 1.05:1 to 1:1.05). For example, for an epoxy resin that has reactive glycidyl groups, a preferred molar ratio of glycyidyl groups in the epoxy resin to amino groups in the curing agent is in a range of 1.2:1 to 1:1.2.

A curable coating composition of the present disclosure also includes a reactive flexibilizing agent and core-shell rubber particles of a type and in an amount that allows coating 10 to withstand cracking when bent at varying degrees per pipe diameter (°/PD) at varying temperatures while maintaining strong adhesion and reduced set-to-touch time.

A “reactive” flexibilizing agent means that it is reactive with one or more components of the curable coating composition such that it is reacted into the polymeric structure. A flexibilizing agent features rotational movement in the backbone of the molecule. Preferred reactive flexibilizing agents are epoxy resins. Examples of suitable reactive flexibilizing agents include, but are not limited to, aliphatic diglycidyl ethers, silicone epoxy resins, polyglycol diglycidyl ethers, carboxylated polymers, polyamides, polyurethanes, epoxy resins based on polypropylene glycol (e.g., polypropylene glycol glycidyl ether), and combinations thereof. Examples of commercially available reactive flexibilizing agents include, but are not limited to, those commercially available under the trade designations ARALDITE DY 3601 from Huntsman Corp., Salt Lake City, Utah, HELOXY 67 from Momentive, Columbus, Ohio, ERISYS GE-24 from CVC Specialty Chemicals, Moorestown, N.J., and HYPRO 1300X13 from Emerald Performance Materials, Akron, Ohio. Various combinations of reactive flexibilizing agents can be used if desired.

Typically, a coating composition of the present disclosure can include at least 0.1 wt-% of a reactive flexibilizing agent, and preferably at least 5 wt-%, based on the total weight of the liquid epoxy resin. Typically, a coating composition of the present disclosure can include no greater than 50 wt-% of a reactive flexibilizing agent, and preferably no greater than 30 wt-%, based on the total weight of the liquid epoxy resin.

The curable coating compositions further include core-shell rubber particles. It has been found that adding core-shell rubber particles, particularly core-shell rubber nanoparticles, increases the elongation of the coating without negatively affecting other coating properties. Suitable core-shell rubber particles are those that increase flexibility of a cured coating of the disclosure.

Preferably, the core-shell rubber particles are nanoparticles (i.e., having an average particle size of less than 1000 nanometers (nm)). Generally, the average particle size of the core-shell rubber nanoparticles is less than 500 nm, e.g., less than 300 nm, less than 200 nm, less than 100 nm, or even less than 50 nm. Typically, such particles are spherical, so the particle size is the diameter; however, if the particles are not spherical, the particle size is defined as the longest dimension of the particle.

Herein, “rubber” refers to natural or synthetic (preferably, synthetic) elastomeric materials. In certain embodiments, the rubber core comprises an acrylate-containing rubber (e.g., a butyl acrylate rubber as in the core-shell particles disclosed in U.S. Pat. No. 6,861,475), a styrene-containing rubber, a diene-containing rubber (e.g., butadiene- and isoprene-containing rubbers), a silicone-containing rubber (e.g., such as that disclosed in U.S. Pat. Pub. No. 2005/124761), copolymers or combinations (e.g., mixtures or blends) thereof. In certain embodiments, the shell polymer has a glass transition temperature of at least 50° C. and the rubber core has a glass transition temperature of no greater than −20° C. In certain embodiments, the shell polymer is selected from the group consisting of an epoxy resin (e.g., a bisphenol A epoxy resin), an acrylate homopolymer, an acrylate copolymer, a styrenic homopolymer, and a styrenic copolymer. Preferred core-shell rubber particles include a crosslinked polybutadiene-containing rubber core with a grafted acrylate homopolymer shell. Exemplary core-shell rubber particles include those available under the trade designations PARALOID 21104XP and PARALOID 2691A (both of which are crosslinked poly(butadiene/styrene) core with a grafted polymethyl methacrylate shell) from Dow Chemical Co., Midland, Mich., as well as that available under the trade designation KANE ACE MX-257 (butadiene-acrylate core-shell rubber particles pre-dispersed in a bisphenol A diglycidyl liquid epoxy resin) from Kaneka Texas Corp., Pasadena, Tex. Various combinations of core-shell rubber particles can be used if desired.

Too high core-shell rubber particle content can lead to poor adhesion to steel, for example, and undesirable aesthetics (e.g., lack of a smooth surface may result). Thus, core-shell rubber particles are preferably used in an amount of no more than 50 wt-% (preferably, no more than 20 wt-%), based on the total weight of the liquid epoxy resin. Typically, a coating composition of the present disclosure includes at least 0.1 wt-% (preferably, at least 5 wt-%) of core-shell rubber particles, based on the total weight of the liquid epoxy resin.

An exemplary curable composition for preparing a cured coating 10 of the present disclosure may also include additional materials in varying concentrations as individual needs may require. For example, the composition may further include one or more fillers, one or more pigments, one or more thixotropes, one or more defoamers, one or more accelerators, one or more adhesion promoters, and combinations thereof.

Examples of suitable pigments include inorganic and organic pigments. Examples of suitable inorganic pigments include, but are not limited to, carbonates, sulfides, silicates, chromates, molybdates, metals, oxides, sulfates, ferrocyanides, carbon, and combinations thereof. Examples of suitable organic pigments include, but are not limited to azo-type (including mono-azo), vat-type, and combinations thereof. Examples of suitable commercially available pigments include, but are not limited to, Titanium Dioxide SMC 1108 from Special Materials Co., Doylestown, Pa., TiONA RCL-9 from Milenium, Grimsby N.E., UK, and HEUCO Green 600734 (also known as Pigment Green 7 or copper phthalocyanine green, chlorinated) from Heubach, Langelsheim, Germany. Various combinations of pigments can be included in a coating composition of the present disclosure if desired.

If desired, a coating composition of the present disclosure can include at least 0.1 wt-% of a pigment, based on the total weight of the liquid epoxy resin. Typically, if used, a coating composition of the present disclosure includes no greater than 5 wt-% of a pigment, based on the total weight of the liquid epoxy resin.

Examples of suitable accelerators include, but are not limited to, metal salts, for example, calcium (Ca⁺²) salts, magnesium (Mg⁺²) salts, bismuth (Bi⁺³) salts, cerium (Ce⁺³) salts, iron salts (Fe⁻³), lead (Pb⁺¹) salts, copper (Cu⁺²) salts, cobalt (Co⁺²) salts, lanthanum (La⁺³) salts, lithium (Li⁻¹) salts, indium (In⁺³) salts, thallium (Th⁺⁴) salts, beryllium (Be⁺²) salts, barium (Ba⁺²) salts, strontium (Sr⁺²) salts, and zinc (Zn⁺²) salts. In many embodiments, the accelerators are selected to be calcium salts, magnesium salts, or lanthanum salts. Suitable anions of the metal salts include, but are not limited to, NO₃⁻, CF₃SO₃⁻, ClO₄⁻, BF₄⁻, CH₃C₆H₄SO₃⁻, and SbF₆⁻. Various combinations of accelerators can be included in a coating composition of the present disclosure if desired.

If desired, an accelerator is used in an amount sufficient to cure the composition under the desired application conditions. The amount of accelerator can be varied to accommodate different application conditions. If desired, a coating composition of the present disclosure can include at least 0.1 wt-% of an accelerator, based on the total weight of the liquid epoxy resin. Typically, if used, a coating composition of the present disclosure can include no greater than 10 wt-% of an accelerator, based on the total weight of the liquid epoxy resin.

Example defoamers include, but are not limited to, those commercially available from BYK USA, Wallingford, Conn. under the trade designation BYK-A-500, and from Synthron, Paris, France under the trade designation MOUSSEX 388 SL. Various combinations of defoamers can be included in a coating composition of the present disclosure if desired.

If desired, a coating composition of the present disclosure can include at least 0.1 wt-% of a defoamer, based on the total weight of the liquid epoxy resin. Typically, if used, a coating composition of the present disclosure can include no greater than 5 wt-% of a defoamer, based on the total weight of the liquid epoxy resin.

Example thixotropes include, but are not limited to, non-reactive polyamide thixotropes such as those commercially available from King Industries, Norwalk, Conn. under the trade designation DISPARLON (e.g., DISPARLON 6500). Various combinations of thixotropes can be included in a coating composition of the present disclosure if desired.

If desired, a coating composition of the present disclosure can include at least 0.1 wt-% of a thixotrope, based on the total weight of the liquid epoxy resin. Typically, if used, a coating composition of the present disclosure can include no greater than 10 wt-% of a thixotrope, based on the total weight of the liquid epoxy resin.

Example adhesion promoters include, but are not limited to, various silane compounds. Some silane compounds that are suitable for adhesion promoters have amino groups or glycidyl groups that can react with one or more components in the curable coating composition. One such silane compound is a glycidoxypropyltrimethoxysilane that is commercially available under the trade designation SILANE Z6040 from Dow Corning, Midland, Mich. Another example is an amino silane (aminopropyltriethoxysilane) commercially available under the trade designations SILQUEST A-1100 or A-1120 from Momentive, Columbus, Ohio. Other exemplary adhesive promoters include various chelating agents such as those described in U.S. Pat. No. 6,632,872 (Pellerite et al.) and various chelate-modified epoxy resins such as those available from Adeka Corporation, Tokyo, Japan under the trade designations EP-49-10N and EP-49-20. These materials contain oxirane groups but are typically added in low amounts to the curable coating composition. Various combinations of adhesion promoters can be included in a coating composition of the present disclosure if desired.

If desired, a coating composition of the present disclosure can include at least 0.1 wt-% of an adhesion promoter, based on the total weight of the coating composition. Typically, if used, a coating composition of the present disclosure can include no greater than 20 wt-% of an adhesion promoter, based on the total weight of the coating composition.

Compositions of the present disclosure can include optional filler materials. As used herein, the term “filler” or “filler material” refers to particulate materials. The filler materials (i.e., fillers) can be inorganic materials, organic materials, or composite materials containing both inorganic and organic materials. Some filler materials have an irregular, spherical, elliptical, or platelet shape. The fillers can have any suitable size. If smooth coatings are desired, the fillers typically have an average particle size no greater than 500 micrometers, no greater than 200 micrometers, no greater than 100 micrometers, or no greater than 50 micrometers.

The fillers can be added to the first part of the curable coating composition, to the second part of the curable coating composition, or to both the first part and the second part of the curable coating composition. Fillers are often added to promote adhesion, to improve corrosion resistance, to control the rheological properties, to reduce shrinkage during curing, to accelerate curing, to absorb contaminants, to improve heat resistance, or for a combination thereof.

Examples of suitable fillers include, but are not limited to, silica-gels, calcium silicates, calcium nitrate, calcium phosphates, calcium molybdates, calcium carbonate, calcium hydroxide, amorphous silica, fumed silica, clays such as bentonite, organo-clays, aluminum trihydrates, glass microspheres, hollow glass microspheres, polymeric microspheres, and hollow polymeric microspheres. The fillers can also be a pigment such as ferric oxide, brick dust, carbon black, titanium oxide and the like. Any of these filler can be surface modified to make them more compatible with the curable or cured coating composition.

Example fillers include, but are not limited to: a mixture of synthetic amorphous silica and calcium hydroxide that is commercially available from W.R. Grace, Columbia, Md. under the trade designation SHIELDEX (e.g., SHIELDEX AC5); a fumed silica treated with polydimethylsiloxane to prepare a hydrophobic surface that is available from Cabot GmbH, Hanau, Germany under the trade designation CAB-O-SIL (e.g., CAB-O-SIL TS 720); a hydrophobic fumed silica available from Degussa, Düsseldorf, Germany under the trade designation AEROSIL (e.g., AEROSIL VP-R-2935); glass beads class IV (250 to 300 micrometers) from CVP S.A. in France; epoxysilane-functionalized (2 wt-%) aluminium trihydrate available under the trade designation APYRAL 24ES2 from Nabaltec GmbH, Schwandorf, Germany; calcium carbonate, and surface-treated calcium carbonate such as that available from Imerys, Rosewell, Ga. under the trade designation IMERSEAL (e.g., IMERSEAL 75); talc such as that available from Luzenac America, Centennial, Colo. under the trade designation MISTRON (e.g., MISTRON 353); and silicates such as that available from Unimin Specialty Minerals, Tamms, Ill. under the trade designation MINEX 4 (sodium potassium alumina silicate) or from Vanderbilt, Norwalk, Conn. under the trade designation VANSIL W-20 (calcium metasilicate). Various combinations of filler materials can be included in a coating composition of the present disclosure if desired.

A curable coating composition of the present disclosure can contain any suitable amount of filler. In many embodiments, the curable coating composition contains at least 0.1 weight percent (wt-%) filler, at least 0.5 wt-%, at least 1 wt-%, or at least 5 wt-%, based on a total weight of the curable or cured coating composition. In many embodiments, the curable coating composition contains no more than 50 weight percent (wt-%) filler, no more than 40 wt-%, no more than 30 wt-%, no more than 20 wt-%, or no more than 10 wt-%, based on a total weight of the curable or cured coating composition. If amounts higher than, e.g., 50 wt-%, are used, there may be an insufficient amount of the polymeric material (e.g., epoxy resin) to provide the desired chemical resistance, corrosion resistance, water resistance, or combination thereof. For example, the amount can be in the range of 0.5 to 50 wt-%, in the range of 1 to 40 wt-%, in the range of 1 to 30 wt-%, in the range of 1 to 20 wt-%, in the range of 1 to 10 wt-%, in the range of 5 to 30 wt-%, or in the range of 5 to 20 wt-%, based on a total weight of the curable or cured coating composition.

A curable coating composition of the present disclosure typically is in the form of a first part and a second part. Additional parts may be used if desired. The first part ideally includes the epoxy resin plus other components that do not react with the epoxy resin. The second part ideally includes the curing agent plus any other components that do not typically react with the curing agent. The components in each part are typically selected such that little or no reactivity occurs within that part.

Alternatively, a curable coating composition of the present disclosure can include additional parts such as a third part that can contain additional components or that can further separate the components of the curable coating composition. For example, the liquid epoxy resin can be in a first part, the curing agent can be in a second part, and any other components can be in the first part, second part, third part, or a combination thereof.

When ready for application, the various parts of the curable coating composition are mixed together to form the cured coating composition. This can be done using via manual, static or dynamic methodologies. These parts are typically mixed together immediately prior to use of the curable coating composition. The amount of each part included in the mixture can be selected to provide, e.g., the desired molar ratio of oxirane groups to amine hydrogen atoms. The particular components are also selected so that the curable coating composition does not form a gel prior to application onto a substrate.

Any suitable application method can be used to apply the curable coating composition to a surface of a substrate. Suitable application methods include, for example, brushing, rolling, spraying, dipping, and the like. For example, a final mixed composition can be applied to a metal (for example, steel) substrate using a brush, roller, or other manual application method, or by spraying onto the substrate using an applicable delivery method. As previously stated, a curable composition could be applied directly over steel, could be applied as a secondary layer over a primary coating on the steel, and/or could bridge a region where it would cover both bare steel and another primary coating.

The curable coating composition can be cured (i.e., polymerized and/or crosslinked) at room temperature, can be cured at room temperature and then at an elevated temperature (e.g., greater than 100° C., greater than 120° C., or greater than 150° C.), or can be cured at an elevated temperature. In some embodiments, the curable coating composition can be cured at room temperature for at least 2 hours, or at least 4 hours. In other embodiments, the curable coating composition can be cured at room temperature for any suitable length of time and then further cured at an elevated temperature such as, for example, 180° C. for a time up to 10 minutes, up to 20 minutes, up to 30 minutes, up to 60 minutes, up to 120 minutes, or even longer than 120 minutes.

A cured coating 10 made from a composition of the present disclosure has desirable flexibility and resistance to cracking when bent. The combination of components, particularly the reactive flexibilizing agent and the core-shell particles, allows coating 10 to withstand cracking when bent at varying degrees per pipe diameter (°/PD) at varying temperatures while maintaining strong adhesion and reduced set-to-touch time. The flexibility properties of the compositions of coating 10 are measured pursuant to a bend test provided below in the Examples Section. As is shown below, exemplary embodiments of coating 10 comply with the CSA Z245.20-06 Section 12.11 Flexibility Test at −30° C. and at room temperature (“RT”).

That is, flexibility can be represented by the observation of no cracks after bending a sample coated with a cured coating 10 by at least 3.0°/PD per the CSA Z245.20-02-12.11 Flexibility Test at RT. More preferably, there are no cracks after bending a sample coated with a cured coating 10 by at least 3.5°/PD per the CSA Z245.20-02-12.11 Flexibility Test at RT (“RT Flex”). Even more preferably, there are no cracks after bending a sample coated with a cured coating 10 by at least 4.0°/PD per the CSA Z245.20-02-12.11 Flexibility Test at RT.

Flexibility can be represented by the observation of no cracks after bending a sample coated with a cured coating 10 by at least 1.0°/PD per the CSA Z245.20-02-12.11 Flexibility Test at −30° C. (“−30 Flex”). More preferably, there are no cracks after bending a sample coated with a cured coating 10 by at least 1.25°/PD per the CSA Z245.20-02-12.11 Flexibility Test at −30° C.

A goal of the present disclosure is to provide desirable properties of a cured coating as characterized by flexibility, cathodic disbondment (CD), and set-to-touch time. In certain embodiments, the RT Flex is preferably at least 4.0 degrees, and the −30 Flex is preferably at least 1.0 degree. Such properties are balanced against a preferred CD value that is relatively low (preferably, below 8 millimeter radius (mmr)). After balancing those two performances, the handling property of set-to-touch is desirably maintained at as low a value as possible (preferably, less than 150 minutes at RT), while maintaining the performance values.

### Exemplary Embodiments

Thus, the following exemplary embodiments of the present disclosure provide coating compositions, cured coatings, methods, and articles. A cured coating is more flexible and damage resistant, providing, e.g., corrosion resistance to pipes, rebar, and other substrates.
1. A curable coating composition having a first part and a second part, the curable coating composition comprising:
   a liquid epoxy resin in the first part of the curable coating composition;
   core-shell rubber particles in the first part or the second part or both;
   a reactive flexibilizing agent in the first part or the second part or both; and
   a curing agent in the second part of the curable coating composition, the curing agent having at least two amino groups of formula —NR¹H where R¹ is selected from hydrogen, alkyl, aryl, or alkylaryl.
2. The curable coating composition of embodiment 1, wherein the epoxy resin comprises an epoxy phenol novolac.
3. The curable coating composition of embodiment 1, wherein the epoxy resin has reactive glycidyl groups and a molar ratio of glycyidyl groups in the epoxy resin to amino groups in the curing agent is in a range of 1.2:1 to 1:1.2.
4. The curable coating composition of any one of embodiments 1 through 3, wherein the core-shell rubber particles comprise core-shell rubber nanoparticles.
5. The curable coating composition of any one of embodiments 1 through 4, wherein the core-shell rubber particles comprise a crosslinked rubber core and a shell comprising a polymer grafted to the crosslinked rubber core.
6. The curable coating composition of embodiment 5, wherein the shell polymer has a glass transition temperature of at least 50° C. and the rubber core has a glass transition temperature of no greater than −20° C.
7. The curable coating composition of embodiment 5, wherein the crosslinked rubber core comprises an acrylate-containing rubber, a styrene-containing rubber, a diene-containing rubber, a silicone-containing rubber, copolymers or combinations thereof.
8. The curable coating composition of embodiment 5, wherein the shell polymer is selected from the group consisting of an epoxy resin, an acrylate homopolymer, an acrylate copolymer, a styrenic homopolymer, and a styrenic copolymer.
9. The curable coating composition of embodiment 5, wherein the core-shell rubber particles comprise a crosslinked polybutadiene-containing rubber core with a grafted acrylate homopolymer shell.
10. The curable coating composition of any one of embodiments 1 through 9, wherein the reactive flexibilizing agent comprises an epoxy resin.
11. The curable coating composition of any one of embodiments 1 through 10 which forms a nonporous coating when applied to a substrate and cured.
12. A curable coating composition having a first part and a second part, the curable coating composition comprising:
   a liquid epoxy resin in the first part of the curable coating composition;
   core-shell rubber particles in the first part or the second part or both; wherein the core-shell rubber particles are present in an amount of 0.1 wt-% to 50 wt-%, based on the total weight of the liquid epoxy resin;
   a reactive flexibilizing agent in the first part of the curable coating composition; wherein the reactive flexibilizing agent is present in an amount of 0.1 wt-% to 50 wt-%, based on the total weight of the liquid epoxy resin; and
   a curing agent in the second part of the curable coating composition, the curing agent having at least two amino groups of formula —NR¹H where R¹ is selected from hydrogen, alkyl, aryl, or alkylaryl.
13. A cured coating comprising a reaction product of a curable coating composition comprising:
   a liquid epoxy resin;
   core-shell rubber particles;
   a reactive flexibilizing agent; and
   a curing agent having at least two amino groups of formula —NR¹H where R¹ is selected from hydrogen, alkyl, aryl, or alkylaryl.
14. An article comprising:
   a substrate having an outer surface; and
   a cured coating disposed on at least a portion of the outer surface;
   wherein the cured coating is prepared by curing a curable coating composition of any one of embodiments 1 through 12.
15. A method of protecting an article, the method comprising:
   coating at least a portion of the article with a curable coating composition comprising components comprising:
      a liquid epoxy resin;
      core-shell rubber particles;
      a reactive flexibilizing agent; and
      a curing agent having at least two amino groups of formula —NR¹H where R¹ is selected from hydrogen, alkyl, aryl, or alkylaryl; and
   curing the composition while disposed on the article.
16. An article prepared by the method of embodiment 15.
17. An article comprising:
   a substrate having an outer surface; and
   a cured coating disposed on at least a portion of the outer surface; wherein the cured coating comprises a reaction product of a curable coating composition comprising:
      a liquid epoxy resin;
      core-shell rubber particles;
      a reactive flexibilizing agent; and
      a curing agent having at least two amino groups of formula —NR¹H where R¹ is selected from hydrogen, alkyl, aryl, or alkylaryl.
18. The article of embodiment 17, wherein the cured coating is the outermost layer of a dual-layer coating system.
19. The article of embodiment 17, wherein the substrate surface comprises steel.
20. The article of embodiment 17, wherein the cured coating is directly coated on the steel surface.

### EXAMPLES

Samples of liquid flexible epoxy resin with flexibilizing agents and core-shell rubber coatings were made and cured. The cured compositions were characterized via the following test procedures to establish flexibility, adhesion, and set-to-touch time.

### Test Methods

### Flexibility

Flexibility testing was carried out according to Canadian Standards Association CSA Z245.20-10 Section 12.11. The test bars were placed in a freezer set at −30° C. for a minimum of one hour or were allowed to remain at room temperature (approximately 21° C.). The test bars were then bent using a mandrel specified to obtain the desired degree per pipe diameter (°/PD). Different mandrel sizes were used to give an estimate of the failure point. The highest degree per pipe diameter that passed was confirmed by repeating the test with three specimens at that °/PD. Cracks with the top 12.7 millimeters (mm) (0.5 inch) of the coating were disregarded.

### Cathodic Disbondment Test

Cathodic Disbondment testing was carried out according to Canadian Standards Association CSA Z245.20-06-12.8. This test is a measurement of the ability to resist cathodic disbondment, which can be considered to be an indicator of adhesion. A 3.2 mm (0.125 inch) diameter holiday was drilled into the center of the panel. The test cell, constructed using a clear polycarbonate tube (diameter×thickness×length) 76.2×6.35×152.4 mm (3×¼×6 inch), was attached to the epoxy surface using 3M Brand Super Silicone No. 08663 or equivalent. Sodium chloride (3%) in deionized water was used as the electrolyte in each cell. The platinum wire used as the anode was inserted through a hole in the top of the cell and a potential difference of −1.5 VDC or −3.5 VDC was applied. The samples were placed in an air circulating oven at either 65° C. or 95° C. The actual potential difference and the level of the electrolyte were checked periodically and adjusted as necessary. At the end of the test period, either 28 or 3 days, adhesion near the holiday was evaluated within one hour by making eight radial cuts and using a utility knife with leveraging action to chip off the coating. The disbondment was measured from the edge of the holiday along the radial cuts and the results were averaged. All values reported are the average of the results obtained on 3 test panels unless otherwise noted.

### Set-to-Touch Time

Set-to-touch time testing was carried out according to American Society for Testing and Materials ASTM D1640 7.2. The samples were lightly touched with the tip of a clean finger. The finger was immediately placed against a piece of clean, clear glass and time observations (in minutes) were taken to determine when none of the coating transferred to the glass. The pressure of the fingertip against the coating was not greater than required to transfer a spot of the coating from 3 to 5 mm (⅛ to 3/16 inch) in cross section.

### Sample Preparation

Table 1 summarizes the materials used to prepare the samples of liquid flexible epoxy resin with core-shell rubber coatings.

TABLE 1
Summary of Materials

| Material | Description | Source |
|---|---|---|
| EPON 828 | Liquid Epoxy Resin | Momentive, Columbus, OH |
| HELOXY 67 | Liquid Epoxy Resin | Momentive, Columbus, OH |
| DY 3601 | Flexibilizing Agent (Epoxy) | Huntsman, Salt Lake City, UT |
| ARADUR 3246 | Amine Curative | Huntsman, Salt Lake City, UT |
| MX-257 | Core-shell Rubber Particle | Kaneka, Pasadena, TX |
| DISPARLON 6500 | Polyamide Thixotrope | King Industries, Norwalk, CT |
| SILQUEST A1120 | Amino Silane Adhesion Promoter | Momentive, Columbus, OH |
| TiONA RCL-9 | Titanium Dioxide Pigment | Milenium, Grimsby, UK |
| HEUCO GREEN | Cu-Phtalocynanine Pigment | Heubach, Langelsheim, DE |
| MISTRON 353 | Silicate Talc Filler | Luzenac, Centennial, CO |
| MINEX 4 | Sodium Potassium Aluminum Silicate | Unimin, Tamms, IL |
| | Filler | |
| MOUSSEX 388 SL | Polysiloxane Defoamer | Synthron, Paris, FR |
| VANSIL W-20 | Calcium Metasilicate Filler | Vanderbilt, Norwalk, CT |

### Preparation of the Samples for Testing

Formulation mixtures F1 to F10 were prepared as shown in Table 2. The numbers in the table refer to the grams of each component in the formulation or define percentages of core-shell and flexibilizing agents by weight with respect to the liquid epoxy resin. The components of formulations F1 to F8 were charged to a DAC mixer MAX 200 cup. Each formulation was mixed for 30 seconds at 1000 revolutions per minute (RPM) and 20 seconds at 2700 RPM in a DAC Mixer 400 FVZ. Raw materials for formulations F9 and F10 were mixed using a high speed mixer with a 76.2 mm (3 inch) diameter high shear cowels mixing blade. The high speed mixer is a Disperamt F105 from VMA-Getzmann GMBH in Germany. Material mixing was at 500 RPM. Formulations F1 to F10 were coated within 5 minutes of mixing.

TABLE 2
Formulation Summary

| | F1 | F2 | F3 | F4 | F5 | F6 | F7 | F8 | F9 | F10 |
|---|---|---|---|---|---|---|---|---|---|---|
| Material | grams | grams | grams | grams | grams | grams | grams | grams | grams | grams |
| EPON 828 | 35.0 | 27.9 | 36.1 | 26.5 | 38.4 | 31.0 | 14.6 | 11.4 | 650 | 830 |
| HELOXY 67 | | | 9.0 | 17.7 | | | | | | |
| DY 3601 | 3.9 | 12 | | | | | 4.9 | 3.3 | 166.4 | 240 |
| ARADUR 3246 | 11.2 | 10.2 | 14.9 | 15.8 | 14.9 | 15.8 | 7.6 | 7.4 | 1006 | 662 |
| KANE ACE MX-257 | | | | | 6.8 | 13.3 | 13 | 17.9 | 566 | 369 |
| DISPARLON 6500 | | | | | | | | | 31.9 | 23.8 |
| SILQUEST A1120 | | | | | | | | | 165.6 | 136 |
| TiONA RCL-9 | | | | | | | | | 41.6 | 49.8 |
| HEUCO GREEN | | | | | | | | | 20.7 | 13.6 |
| MISTRON 353 | 20 | 20 | 25 | 25 | 25 | 25 | 10 | 10 | 0 | 862 |
| MINEX 4 | | | | | | | | | 0 | 862 |
| MOUSSEX 388 SL | | | | | | | | | 20.4 | 17.9 |
| % flexibilizing agent with | 11 | 43 | 25 | 67 | | | 21 | 15 | 17 | 23 |
| respect to weight of liquid | | | | | | | | | | |
| epoxy resin | | | | | | | | | | |
| % core-shell rubber with | | | | | 5.9 | 12.4 | 21 | 29 | 21 | 13 |
| respect to weight of liquid | | | | | | | | | | |
| epoxy resin | | | | | | | | | | |

### Comparative Examples 1-6 and Examples 7-10

The flexible epoxy resins discussed herein were made by coating on hot rolled steel with dimensions of 25.4×203.2×9.52 mm (1×8×⅜ inch) for flex testing and on hot rolled steel with dimensions of 101.6×101.6×3.2 mm (4×4×⅛ inch) for cathodic disbondment testing. The steel specimens were solvent washed with methylethylketone (in accordance with SSPC-SP1) followed by an isopropanol rinse. The dry steel surface was grit blasted to a near-white finish in accordance with NACE No. 2/SSPC-SP10 1508501-5A2.5. The steel specimens were coated with the flexible epoxy resin in a manner to give a coating thickness of approximately 20 mils. The coated specimens were then allowed to air dry for a period of a minimum of 7 days at room temperature.

Results of the testing are summarized in Table 3. Formulations F1 to F10, as defined in Table 2, directly correlate to comparative examples (CE1 to CE6) and examples (E7 to E10) where F1 to F6 are CE1 to CE6 and F7 to F10 are E7 to E10, respectively. CE1 excluded the presence of core-shell rubber particles in the liquid epoxy resin with a curative and included the flexibilizing agent, which resulted in flexibility (°/PD) less than preferred at RT (≧4.0°/PD) or −30° C. (≧1.25°/PD). CE2, which also excluded core-shell rubber particles in the liquid epoxy resin with a curative, met the needs of flexibility at RT and −30° C. due to the presence of a larger quantity of the flexibilizing agent, but resulted in a set-to-touch time much greater than preferred. CE3 excluded both core-shell rubber particles and the flexibilizing agent in two liquid epoxy resins with a curative, which resulted in preferred set-to-touch time performance, but flexibility for RT and −30° C. was less than preferred. CE4 excluded both core-shell rubber particles and the flexibilizing agent in two liquid epoxy resins with a curative, which resulted in preferred flexibility at RT and −30° C., but set-to-touch time performance was less than preferred. CE5 and CE6 included core-shell rubber particles in the liquid epoxy resin with a curative, but removal of the flexibilizing agent resulted in RT and −30° C. flexibility less than preferred. E7 to E10 included both core-shell rubber particles and flexibilizing agents in the liquid epoxy resin with a curative, and resulted in preferred flexibility and set-to-touch time performance.

TABLE 3
Sample Testing Results

| Example | CE1 | CE2 | CE3 | CE4 | CE5 | CE6 | E7 | E8 | E9 | E10 |
|---|---|---|---|---|---|---|---|---|---|---|
| Flexibility | 1.4 | 7.75 | 0.9 | 6.3 | 0.9 | 0.9 | 4.0 | 6.3 | 6.3 | 4.0 |
| °/PD RT | | | | | | | | | | |
| Flexibility | <1.0 | 1.4 | <1.0 | 1.4 | <1.0 | <1.0 | 1.5 | 1.5 | 2.2 | 1.7 |
| °/PD −30° C. | | | | | | | | | | |
| Set-to-Touch | 120 | >300 | 180 | >300 | 90 | 90 | 150 | 140 | 135 | 135 |
| Time (min) | | | | | | | | | | |
| CD, 95° C., 3 | 3.8 ± 0.3 | 3.5 ± 0.3 | | 6.4 ± 1.2 | | | | | | |
| day, 3.5 V | | | | | | | | | | |
| CD, 65° C., 28 | | | | | | | | | 13 ± 0.5 | 4.3 ± 0.5 |
| day, 1.5 V | | | | | | | | | | |

The complete disclosures of the patents, patent documents, and publications cited herein are incorporated by reference in their entirety as if each were individually incorporated. Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows.

1. A curable coating composition having a first part and a second part, the curable coating composition comprising:
a liquid epoxy resin in the first part of the curable coating composition;
core-shell rubber particles in the first part or the second part or both;
a reactive flexibilizing agent in the first part or the second part or both; and
a curing agent in the second part of the curable coating composition, the curing agent having at least two amino groups of formula —NR¹H where R¹ is selected from hydrogen, alkyl, aryl, or alkylaryl.

2. The curable coating composition of claim 1, wherein the epoxy resin comprises an epoxy phenol novolac.

3. The curable coating composition of claim 1, wherein the epoxy resin has reactive glycidyl groups and a molar ratio of glycyidyl groups in the epoxy resin to amino groups in the curing agent is in a range of 1.2:1 to 1:1.2.

4. The curable coating composition of claim 1, wherein the core-shell rubber particles comprise core-shell rubber nanoparticles.

5. The curable coating composition of claim 1, wherein the core-shell rubber particles comprise a crosslinked rubber core and a shell comprising a polymer grafted to the crosslinked rubber core.

6. The curable coating composition of claim 5, wherein the shell polymer has a glass transition temperature of at least 50° C. and the rubber core has a glass transition temperature of no greater than −20° C.

7. The curable coating composition of claim 5, wherein the crosslinked rubber core comprises an acrylate-containing rubber, a styrene-containing rubber, a diene-containing rubber, a silicone-containing rubber, copolymers or combinations thereof.

8. The curable coating composition of claim 5, wherein the shell polymer is selected from the group consisting of an epoxy resin, an acrylate homopolymer, an acrylate copolymer, a styrenic homopolymer, and a styrenic copolymer.

9. The curable coating composition of claim 5, wherein the core-shell rubber particles comprise a crosslinked polybutadiene-containing rubber core with a grafted acrylate homopolymer shell.

10. The curable coating composition of claim 1, wherein the reactive flexibilizing agent comprises an epoxy resin.

11. The curable coating composition of claim 1 which forms a nonporous coating when applied to a substrate and cured.

12. A curable coating composition having a first part and a second part, the curable coating composition comprising:
a liquid epoxy resin in the first part of the curable coating composition;
core-shell rubber particles in the first part or the second part or both; wherein the core-shell rubber particles are present in an amount of 0.1 wt-% to 50 wt-%, based on the total weight of the liquid epoxy resin;
a reactive flexibilizing agent in the first part of the curable coating composition; wherein the reactive flexibilizing agent is present in an amount of 0.1 wt-% to 50 wt-%, based on the total weight of the liquid epoxy resin; and
a curing agent in the second part of the curable coating composition, the curing agent having at least two amino groups of formula —NR¹H where R¹ is selected from hydrogen, alkyl, aryl, or alkylaryl.

13. A cured coating comprising a reaction product of a curable coating composition comprising:
a liquid epoxy resin;
core-shell rubber particles;
a reactive flexibilizing agent; and
a curing agent having at least two amino groups of formula —NR¹H where R¹ is selected from hydrogen, alkyl, aryl, or alkylaryl.

14. An article comprising:
a substrate having an outer surface; and
a cured coating disposed on at least a portion of the outer surface;
wherein the cured coating is prepared by curing a curable coating composition of claim 1.

15. A method of protecting an article, the method comprising:
coating at least a portion of the article with the curable coating composition of claim 1; and
curing the composition while disposed on the article.

16. An article prepared by the method of claim 15.

17. (canceled)

18. The article of claim 14, wherein the cured coating is the outermost layer of a dual-layer coating system.

19. The article of claim 14, wherein the substrate surface comprises steel.

20. The article of claim 19, wherein the cured coating is directly coated on the steel surface.
